(19) United States
(12) Patent Application Publication
(10) Pub. No.: US 2018/0345471 A1
(43) Pub. Date: Dec. 6, 2018

(54) MULTI-PURPOSE ELECTRICAL TOOL

(71) Applicant: Allison Sookoo, San Fernando (TT)

(72) Inventor: Allison Sookoo, San Fernando (TT)

(21) Appl. No.: 16/001,519

(22) Filed: Jun. 6, 2018

Related U.S. Application Data
(60) Provisional application No. 62/603,605, filed on Jun. 6, 2017.

(51) Int. Cl. B25F 1/00; B25G 1/10; B23D 29/02; B25B 15/04; B25F 1/04; H02G 1/12; H02G 1/00

(52) U.S. Cl. CPC B25F 1/003; B25G 1/102; B23D 29/023; B25G 1/085; B25F 1/04; H02G 1/1209; H02G 1/005; B25B 15/04

(57) ABSTRACT

A multi-purpose electrical tool is described herein for electrical wiring manipulations. The multi-purpose electrical tool combines the functions of several different tools, for example gripping, bending, cutting, stripping, and curling, and the like, into a single tool. The multi-purpose electrical tool comprises two body members attached at a pivot point and two jaws portions. The jaw portions move open and closed when the body members are opened and closed, facilitating cutting functions. The jaw portions also allow for wire curling. One of the body members includes a slot for inserting a screwdriver into the slide for its immediate use.

### CROSS-REFERENCE TO RELATED APPLICATIONS

This application claims the benefit of U.S. Provisional Pat. App. No. 62/603,605 filed on Jun. 6, 2017, the entire disclosure of which is hereby incorporated by reference in its entirety.

### BACKGROUND

Today's electricians utilize several of tools in their daily work, for example, pliers, wire cutters, strippers, screwdrivers, and the like. Electricians must frequently switch between these tools when necessary to achieve several different functions.

Electricians often work in tight spaces that may constrain their physical movements such as roofs, cellars, attics, crawlspaces, or the like. Therefore, it may be critical for them to minimize their physical movements particularly when extracting a tool from their belt to perform the work and returning that tool to their belt.

Electricians may often climb and/or work from ladders with their tool belt hanging from their waist. They may experience awkward positions rendering their tools inaccessible to them while standing on a ladder. Electricians may also carry their tools up stairways to gain access to their job locations. Once there, they repair or lay wire in confining spaces all day, burdened by their fully loaded tool belt. Fatigue and stress may combine to reduce productivity leading to productivity losses.

Moreover, an electrician may leave their tool at a worksite, travel to another worksite only to realize when they arrive there, that necessary tool is missing.

Therefore electricians must have the right tools to perform their job functions at all times. A need exists for a tool that incorporates multiple functions while minimizing the mechanical movements, lessening the weight of an electrician's tool belt and is capable of improving productivity.

### SUMMARY OF INVENTION

A multi-purpose hand tool is described herein. The multi-purpose hand tool may include a wire-stripper, a wire-curler, a screwdriver, a wire-nut driver, a wire cutter, and pliers. The multi-purpose electrical tool may combine several different mechanical functions into a single tool. The multi-purpose electrical tool comprises two body members attached at a pivot point and two jaws portions. The jaw portions move open and closed when the body members are opened and closed, facilitating cutting functions. The jaw portions also allow for wire curling. One of the body members includes a slot for inserting a screwdriver into the slide for its immediate use.

### BRIEF DESCRIPTION OF DRAWINGS

FIG. 1 show an example of a multi-purpose electrical tool;

FIG. 2 shows an exploded view of a multi-purpose electrical tool;

FIG. 3 shows a bottom of one of the multi-purpose electrical tool handles;

FIG. 4 shows examples of screwdriver heads;

FIGS. 5A and 5B show an example of a side wrapped screwdriver assembly;

FIG. 6 shows another example of a side wrapped screwdriver assembly;

FIG. 7 shows an example of a back wrapped screwdriver assembly;

FIG. 8 shows an example of a wire curler;

FIG. 9 shows another example of a wire curler;

FIG. 10 shows an example of a wire nut driver;

FIG. 11 shows another example of a wire nut driver;

FIG. 12 shows an example of a wire stripper/cutter; and

FIG. 13 shows an example of a wire twister.

### DETAILED DESCRIPTION OF THE DRAWINGS

This invention is described in the following description with reference to the Figures, in which like reference numbers represent the same or similar elements. While this invention is described in terms of modes for achieving this invention's objectives, it will be appreciated by those skilled in the art that variations may be accomplished in view of these teachings without deviating from the spirit or scope of the present invention. The embodiments and variations of the invention described herein, and/or shown in the drawings, are presented by way of example only and are not limiting as to the scope of the invention.

Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

A multi-purpose electrical tool is described herein. The multi-purpose electrical tool may combine several different mechanical functions into a single tool. The multi-purpose electrical tool may include a wire stripper, pliers, wire curler, screwdriver, wire nut driver, and wire cutter. These features allow you to accomplish tasks commonly encountered in electrical wiring and installation work. The multi-purpose electrical tool may make it quick and easy to get from stripping the conductor to making the connections on electrical apparatuses and equipment.

The multi-purpose electrical tool may provide a system of stripping the insulation, twisting the conductors, and curling the twisted stranded conductors into a circular pattern as lug for various sizes in domestic, commercial, and industrial applications. The screwdriver may then be used to slacken the screws and tighten the curled conductor on the electrical apparatus for a mechanically and electrically sound connection.

The pliers may include plier-like jaw having jagged edges to grip materials and wires. The plier-like jaws may cut electrical wires while another portion of the jaws may allow the electrician to curl the wire. The stripping function may allow a user to strip electrical insulation from wires in a quick and easy manner. The plier-like jaws may include a set of holes that allow an electrician to properly size wire gages, even in unsatisfactory conditions, for example, dark and/or confined spaces.

The multi-purpose electrical tool may combines several functions into a single tool, replacing all other tools performing these functions. The multi-purpose electrical tool may occupy a minimal amount of storage space on an electrician's tool belt, facilitating bodily movements by electricians who are typically confined to small spaces, for example attics, closets, or the like, where such movements are difficult to achieve.

The multi-purpose electrical tool may offer a cost effective alternative to multiple tool expenditures.

The screwdriver may attach to one of the handles of the multi-purpose electrical tool allowing a user to quickly, after stripping insulation or cutting or curling wire, obtain the screwdriver and immediately connect the that wire to the electrical terminal without the need to switch tools.

The multi-purpose electrical tool may be capable of stripping, curling, twisting, cutting and sizing electrical wires. The multi-purpose electrical tool may be comprised of two members connected together at a pivot point, establishing two opposing jaws and two opposing handles one on each side of the pivot point.

The jaws may provide a means for cutting electrical wire, stripping electrical insulation away from the wire without nicking or damaging the wire. The jaws may also allow the electrician to curl wires. The jaws also permit the electrician to size wire gages.

One handle of the multi-purpose electrical tool may provide a means for twisting wires together. Electricians may twist wires together of stranded conductors of, for example, 1.5 mm, 2.5 mm, and 4.0 mm. In addition several number of 1.5 mm, 2.5 mm, or 4.0 mm strands may be twisted together by the nut-driver. The multi-purpose electrical tool may contain a handle that separates, revealing a twisting apparatus. The twisting apparatus may efficiently twist the stranded conductors and obviate the use of pliers. The result of the twisting may be an electrical connection that is electrically and mechanically sound for insertion into screws of various apparatuses.

It is an objective of this invention to provide the electrician with a tool that minimizes the physical movements required by them especially in tight and confining spaces.

It is an objective of this invention to provide a tool that permits the electrician to immediately and accurately screw wire connections to terminals and connectors without switching tools in the midst of a work assignment.

It is an objective of the present invention to offer a tool that minimizes the weight of tools the electrician must carry in their tool belt. The present invention combines several tools into one, thus minimizing the number and weight of the required tools.

It is an objective of the present invention to minimize the number of tools the electrician must carry in their tool belt and thus minimize the potential for misplaced tools.

Another objective of the present invention is to provide a tool that incorporates comfortable and unique handgrips, facilitating ease of use of the tool for long periods of time.

A multi-purpose electrical tool hand tool may have two body members comprising a handle and a jaw component. A connection of the two body members may be a pivot point, joining the two body members together such that it permits an open and closed position with each of the two body members. The multi-purpose electrical tool may combine several electrical functions commonly found in multiple tools into one. As the two body members open and close, the jaw portion of the tool may open and close. Between the two body members may be a tension spring adapted to exert force against each of the body members gently pushing each of them apart.

The jaw portions of the multi-purpose electrical tool may operate to cut wire by placing that wire directly into the path of the closing jaws.

The multi-purpose electrical tool may also include a screwdriver inserted into one of the handles at the rear of the tool. An electrician may remove the screwdriver from the handle as needed.

The multi-purpose electrical tool may also include a twisting function. The twisting function may allow the electrician to twist multiple wires together and intertwine. This may result in in greater strength and easier connection into electrical nuts.

The multi-purpose electrical tool may also include a sizing function of electrical wires of various gages that permit the electrician to size the wire gauge.

The multi-purpose electrical tool may also include a wire-curler. The wire curler may allow the electrician to curl electrical wires at the tip of the jaw portion.

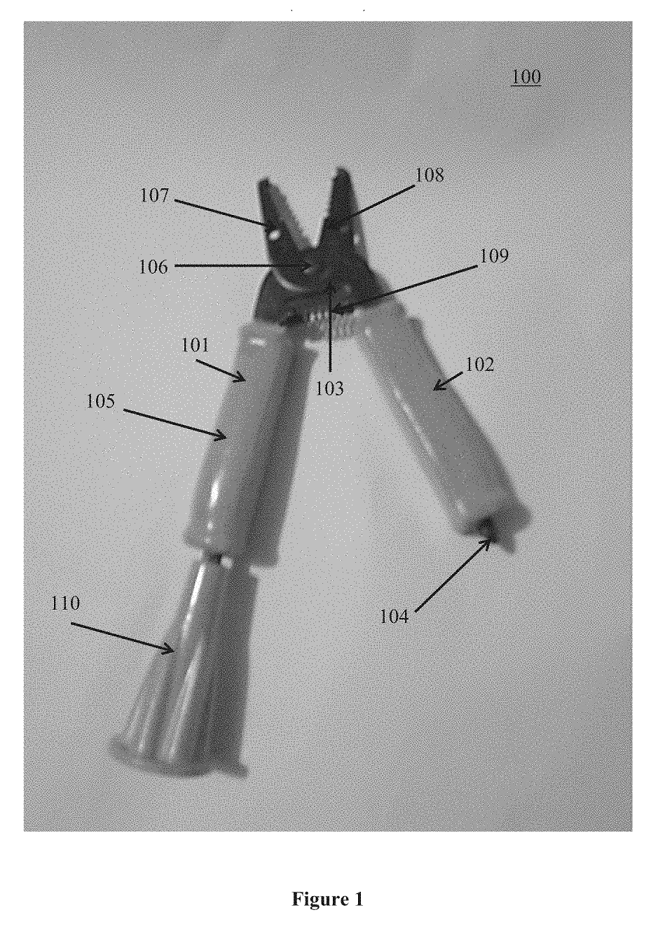

FIG. 1 shows an example of a multi-purpose electrical tool. The multi-purpose electrical tool 100 has a body that extends in the forward and rearward direction having two body members 101 and 102 connected at a pivot point 103. Each body member 101 and 102 may have a handle 104 and 105. The handles 104 and 105 may extend rearward of the pivot point 103. The two body members 101 and 102 may be connected to each other at a pivot point 103 extending through each body member 101 and 102. The pivot point 103 may lay on a flat axis to each body member 101 and 102. The pivot point 103 may be secured by a bolt 106.

On the forward end of the pivot point 103 may be two jaw portions 107 and 108. The jaw portions 107 and 108 may open and close when the handles 104 and 105 are squeezed, compressing a tension spring 109. The jaw portions 107 and 108 remain in an open position at rest and are only closed when the tension spring 109 is compressed.

The tension spring 109 may provide an external bias outwardly. The electrician may compress the body member 101 and 102 closing of the jaw portions 107 and 108. Upon release of pressure, the tension spring 109, which is permanently affixed to the body members by welding or the like, may return the body members to an open position.

The multi-purpose electrical tool may have a screwdriver 110 inserted into the end of handle 105. The screwdriver 110 may be removed from handle 105 by pulling it out of a slot in handle 10.

The handles 104 and 105 may be made of non-conductive, non-corrosive grips. The grips may have an ergonomic design to allow the electrician to precisely open, close and manipulate the multi-purpose electrical tool.. The grips may be surrounded with electrically insulated materials to prevent transmission of electrical discharge to the user.

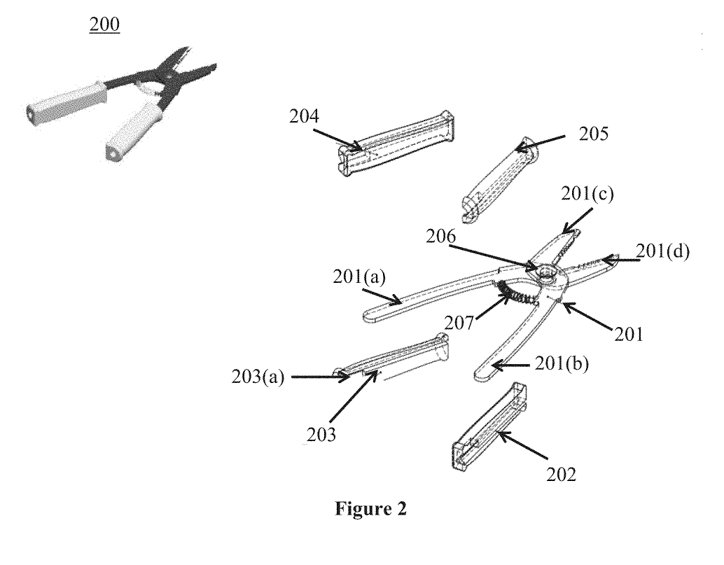

FIG. 2 shows an exploded view of the multi-purpose electrical tool. The multi-purpose electrical tool 200 includes a wire stripper 201. The wire stripper 201 may act as the base of the multi-purpose electrical tool 200. The wire stripper 201 may include two handles 201(a) and 201(b) and two jaw portions 201(c) and 201(d). The handles and jaw portions (201(a)-(d)) connect at a pivot point 206. The two jaw portions 201(c) and 201(d) are engaged by applying squeezing the two handles 201(a) and 201(b) compressing a tension spring 207.

On a first handle portion 201(a) of the multi-purpose electrical tool 200 may be a wire-curler 203 and 205. The two halves of the wire-curler 203 and 205 may be joined together to encase the first handle portion 201(a). One half of the wire curler 203 may include a slot for a screwdriver 203(a). On a second handle portion 201(b) of the multi-purpose electrical tool 200 may be jaws for stripping insulation 202 and 204. The two halves of the jaws for stripping insulation 20 may be joined together to encase the second handle portion 201(b).

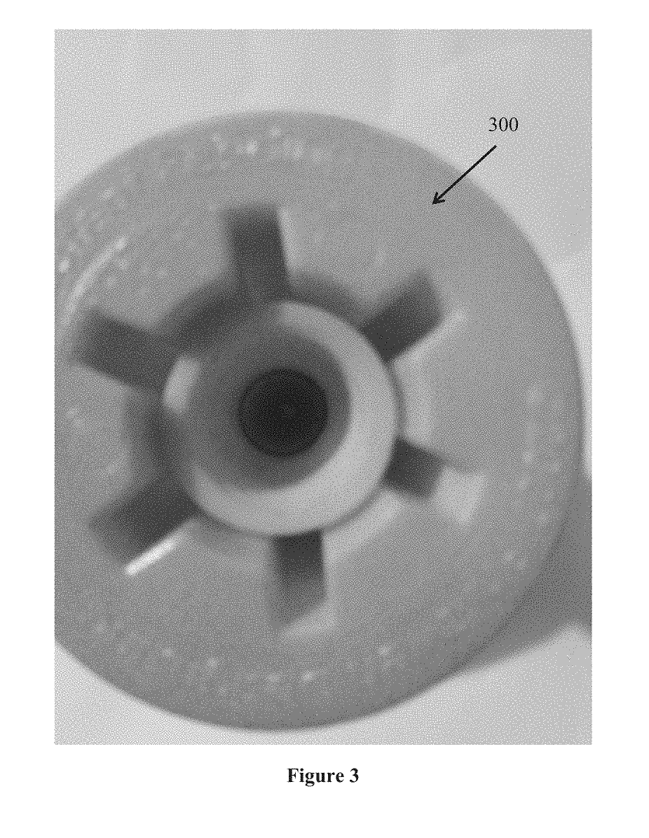

FIG. 3 shows a bottom of one of the multi-purpose electrical tool handles. The bottom of one of the multi-purpose electrical tool handles has a screwdriver inserted into slot (as illustrated in FIG. 1 by reference number 110 and in FIG. 2 by reference number 203(a)). At the bottom of the screwdriver may be a nut driver 300.

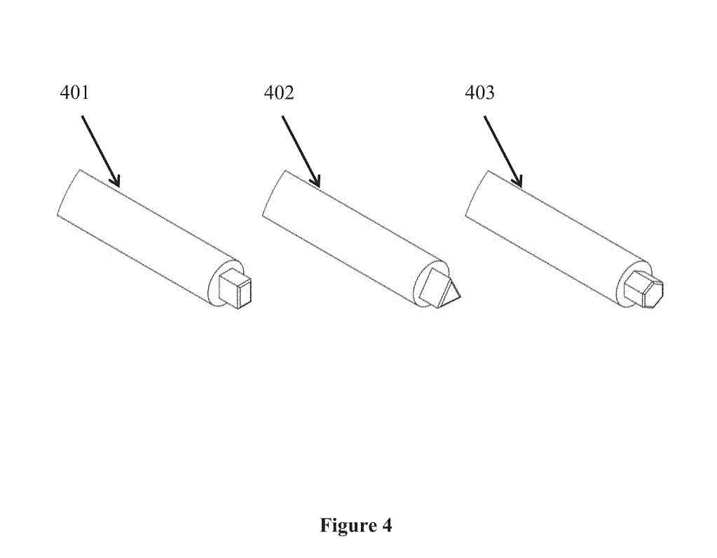

FIG. 4 shows examples of screwdriver heads. When the screwdriver is removed from the slot in the wire curler, a head may need to be attached. For example, a screwdriver head may be hexagonal 401, rectangular 402, or rectangular 403.

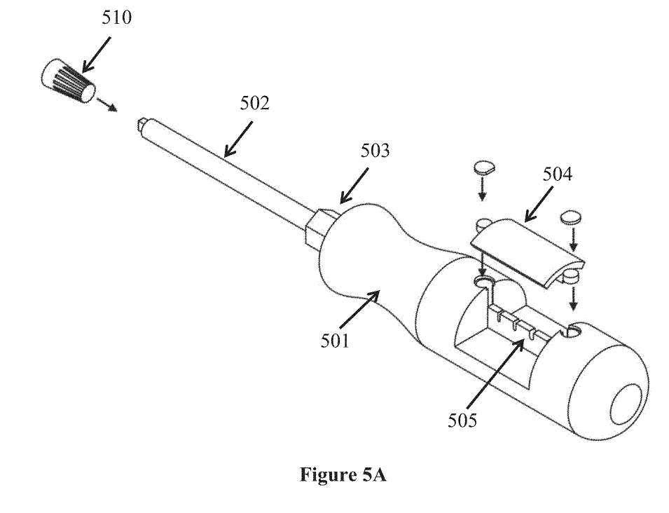

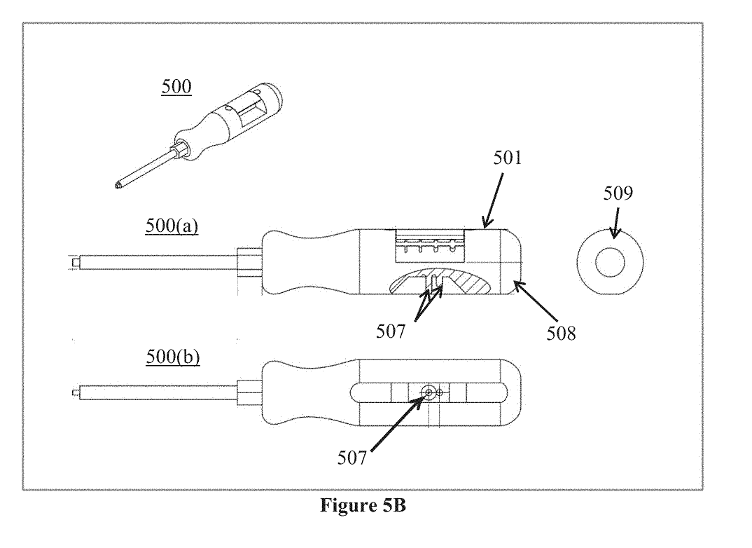

FIGS. 5A and 5B show an example of a side wrapped screwdriver assembly. In FIG. 5A, a side wrapped screwdriver assembly may include a handle 501, a shaft 502, and a connector 503. A head 510 may connect to the end of the screwdriver shaft 502. The handle 501 of the screwdriver may have a wire stripper 505. The wire stripper 505 may include four different holes sizes, for example, 0.5 millimeter (mm), 1.5 mm, 2.5 mm and 4.0 mm 165.

The wire stripper 505 may be created by a removable panel 504 that attaches to the handle 501 of the screwdriver. The removable panel of the screwdriver 504 may be attached using connectors, for example, screws and the like.

In FIG. 5B, the side wrapped screwdriver assembly 500 is shown from the side 500(a) and the bottom 500(b). The side wrapped screwdriver handle 501 may have a wire curler 507. The wire curler 507 may have two gauges, for example, 6 mm or 2.5 mm. At the end 508 of the handle 501 is a wire-nut driver 509.

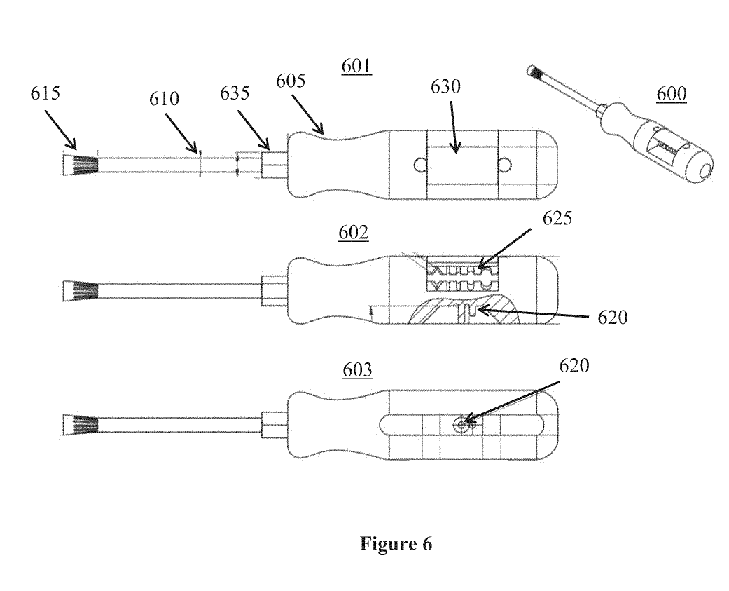

FIG. 6 shows another example of a side wrapped screwdriver assembly. The side wrapped screwdriver assembly 600 is shown from the top 601, the side 602, and the bottom 603. The side wrapped screwdriver assembly (600, 601, 602, and 603) may include a handle 605, a shaft 610, and a wire twister 615. The side wrapped screwdriver assembly 602 and 603 may include a wire curler 620 on the bottom of the handle 605. The wire twister 615 may attach to the shaft 610.

The handle 605 of the side wrapped screwdriver assembly (600, 601, 602, and 603) may include a wire stripper/cutter 625. The wire stripper/cutter 625 may be created by a removable panel 630 that attaches to the handle 605 of the side wrapped screwdriver assembly (600, 601, 602, and 603). The removable panel may be attached using connectors, for example, screws and the like.

The screwdriver assembly described herein may be ratcheting. The joint 635 where the handle 605 attaches to the shaft 610 is a ratcheting joint 635. The ratcheting may allow the user to easily maneuver the screwdriver in confined spaces.

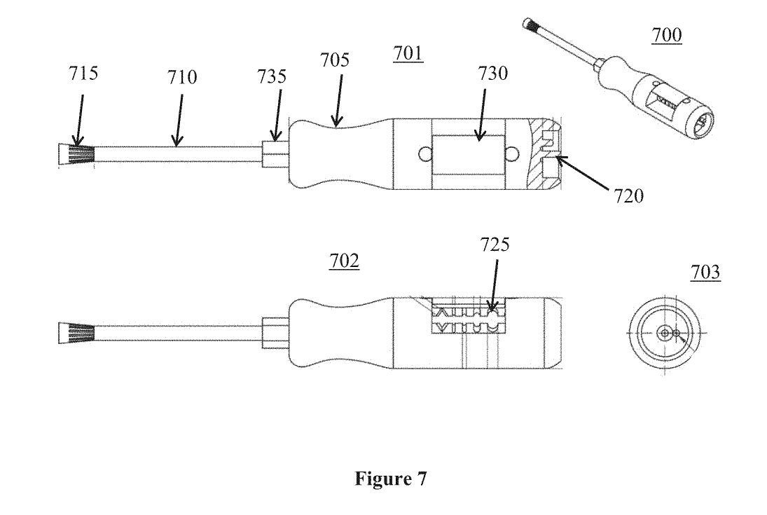

FIG. 7 shows an example of a back wrapped screwdriver assembly. The back wrapped screwdriver assembly 700 is shown from the top 701, the side 702, and the back 703. The back wrapped screwdriver assembly (700, 701, and 702) may include a handle 705, a shaft 710, and a wire twister 715. A wire curler 720 may be located at the opposite side of the handle 705 from the shaft 710.

The handle 705 of the back wrapped screwdriver assembly (700, 701, and 702) may include a wire stripper/cutter 725. The wire stripper/cutter 725 may be created by a removable panel 730 that attaches to the handle 705 of the back wrapped screwdriver assembly (700, 701, and 702). The removable panel may be attached using connectors, for example, screws and the like. The screwdriver assembly described herein may be ratcheting. The joint 735 where the handle 705 attaches to the shaft 710 is a ratcheting joint 735. The ratcheting may allow the user to easily maneuver the screwdriver in confined spaces.

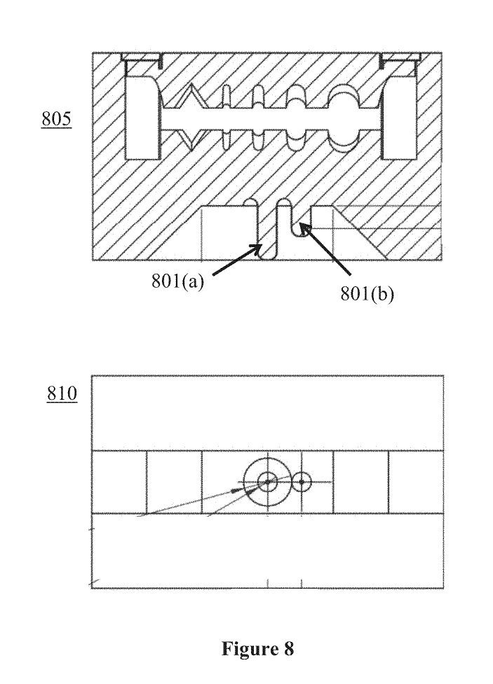

FIG. 8 shows an example of a wire curler. The wire curler 800 is shown from both a side view 805 and a bottom view 810 in FIG. 8. The wire curler 800 may have two gauges 801a and 801b, for example, 6 mm or 2.5 mm. The wire curler shown in FIG. 8 may be located on an underside of the side wrapped screwdriver.

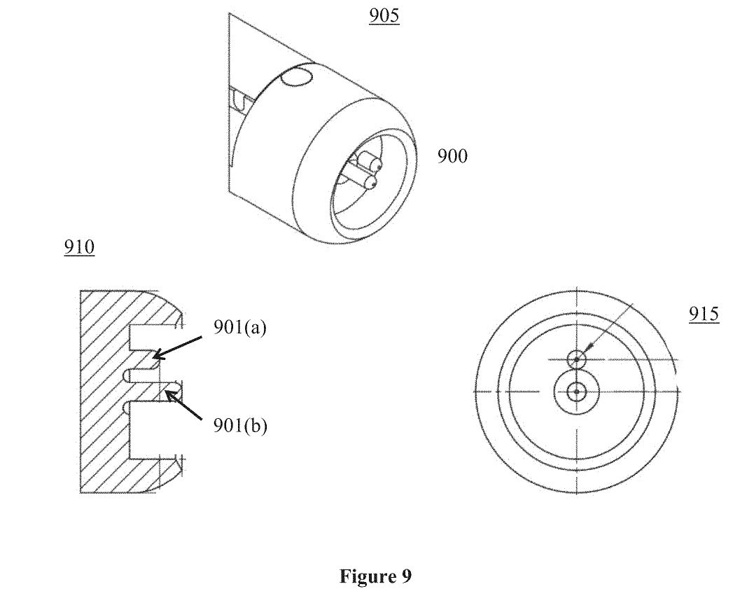

FIG. 9 shows another example of a wire curler. The wire curler 900 is shown from a perspective view 905, a side view 910, and a top view 915. The wire curler 900 may have two gauges 901(a) and 901(b), for example, 4 mm and 2.5 mm. The wire curler shown in FIG. 9 may be located at the opposite side of the handle from the shaft on a back wrapped screwdriver.

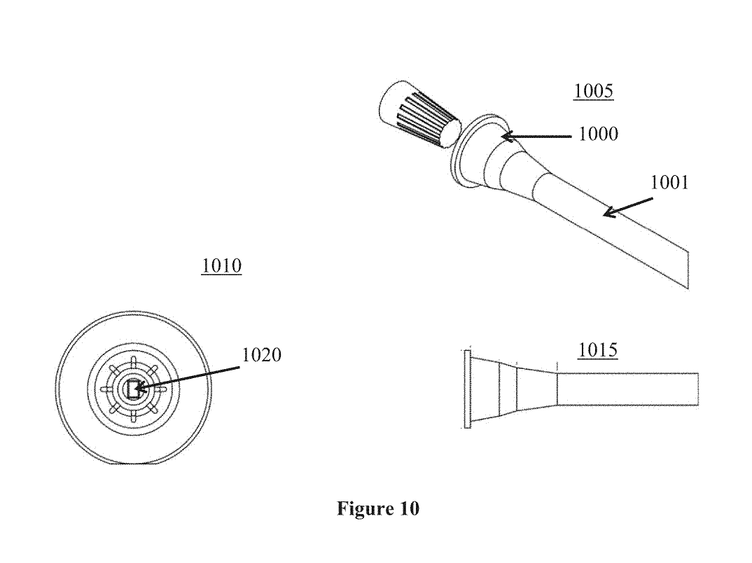

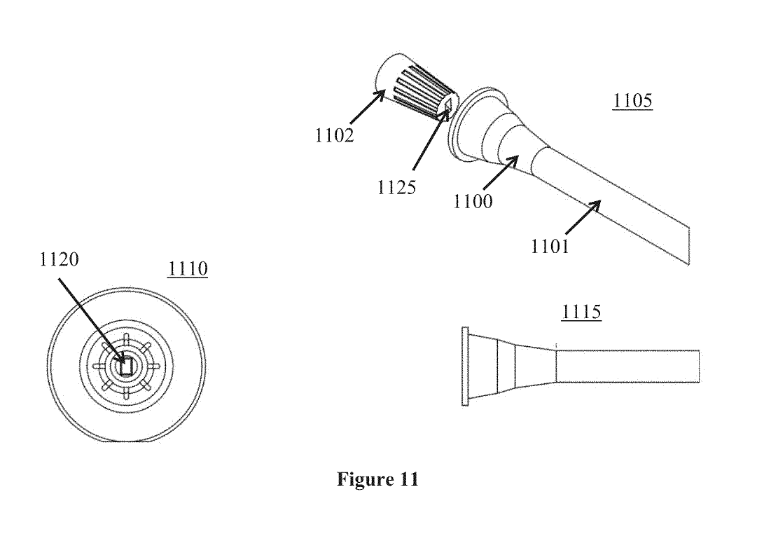

FIG. 10 shows an example of a wire nut driver. The wire nut driver 1000 is shown from a perspective view 1005, a bottom view 1010, and a side view 1015. The wire nut driver 1000 may be attached to the shaft 1001 of a screwdriver. The wire nut driver 1000 may be cone-shaped and may have a rectangular shaped protrusion 1020. The rectangular shaped protrusion 1020 may fit into a wire nut 1002 (as illustrated in FIG. 11). The wire nut driver 1000 may be approximately 15 mm in length.

FIG. 11 shows another example of a wire nut driver. The wire nut driver 1100 is shown from a perspective view 1105, a bottom view 1110, and a side view 1115. The wire nut driver 1100 may be attached to the shaft 1101 of a screwdriver. The wire nut driver 1100 may be cone-shaped and may have a rectangular shaped protrusion 1120. The rectangular shaped protrusion 1120 may fit into a rectangular shaped hole of a wire nut 1102. The wire nut driver 1100 may be approximately 15 mm in length.

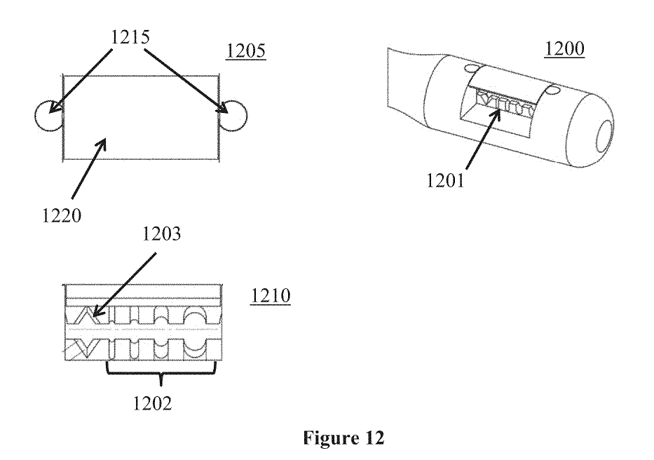

FIG. 12 shows an example of a wire stripper/cutter. The wire stripper/cutter 1201 is shown from a perspective view 1200, a top view 1205, and a side view 1210. The wire cutter/stripper 1201 may be located within a handle of the screwdriver. The wire stripper/cutter 1201 may include four (4) wire gauges 1202 for wire stripping. For example, the wire gauges may be 1 mm, 1.5 mm, 2.5 mm, and 4 mm. The wire stripper/cutter 1201 may also include a wire cutter 1203.

The wire stripper/cutter 1201 may be created by a removable panel 1204 that attaches to the handle of the screwdriver. The removable panel 1215 may be attached using connectors 1220, for example, screws and the like.

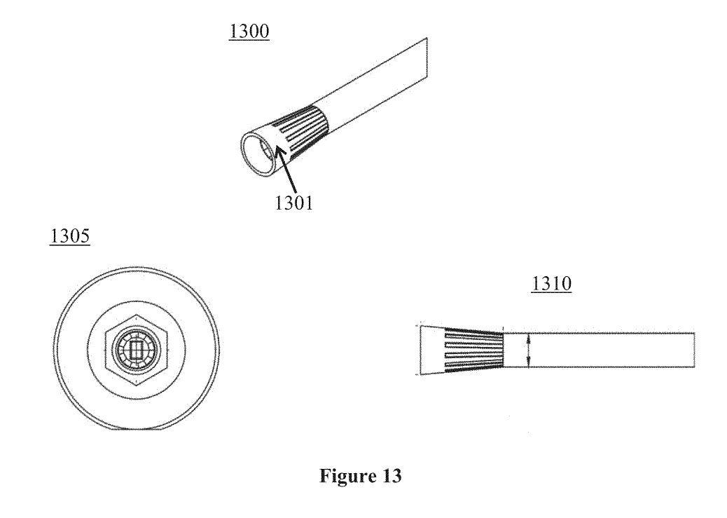

FIG. 13 shows an example of a wire twister. The wire twister 1301 is shown from a perspective view 1300, a bottom view 1305, and a side view 1310. The wire twister 1301 may attach to the shaft of a screwdriver. The wire twister 1301 may be cone shaped and 14 mm in length.

The multi-purpose electrical tool may operate manually, semi-automatically, or fully-automatically. The multi-purpose electrical tool may further include a voltage tester and a torchlight. If the multi-purpose electrical tool is semi- or fully automatic, it may require the use of a battery or internal circuits for charging. The battery may be rechargeable as well.

The multi-purpose electrical tool may include a button to operate the screwdriver assembly for a semi- or fully automatic embodiment. The screwdriver assembly and attachments, for example, a wire twister, may all operate automatically. This may assist the user in quick and efficient operation of the multi-purpose electrical tool. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments. While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed:

1. A multi-purpose electrical tool comprising:
a wire-stripper,
a wire-curler;
a screwdriver;
a wire-nut driver;
a wire cutter; and
a pliers;
wherein the multi-purpose electrical tool has at least two body members that are connected at a pivot point; and
wherein the at least two body members have at least two handles and at least two jaws.

2. The multi-purpose electrical tool of claim 1, wherein the screwdriver fits into a slot in at least one handle of the multipurpose electrical tool.

3. The multi-purpose electrical tool of claim 1, further comprising a tension spring.

4. The multi-purpose electrical tool of claim 3, wherein the tension spring is compressed to close the at least two body members.

5. The multi-purpose electrical tool of claim 1, wherein the wire-curler is attached to at least one handle.

6. The multi-purpose electrical tool of claim 1, wherein the wire-nut driver is at the end of the screwdriver.

7. The multi-purpose electrical tool of claim 1, wherein the screwdriver further comprises a wire gauge.

8. The multi-purpose electrical tool of claim 1, wherein the at least two handles are ergonomic.

9. The multi-purpose electrical tool of claim 1, wherein the at least two handles are made of a non-corrosive material.

10. The multi-purpose electrical tool of claim 1, further comprising jaws for stripping insulation.

11. The multi-purpose electrical tool of claim 10, wherein the jaws for stripper insulation is attached to at least one handle.

12. The multi-purpose electrical tool of claim 1, wherein the screwdriver is ratcheting.
